(19) United States
(12) Patent Application Publication
(10) Pub. No.: US 2017/0316265 A1
(43) Pub. Date: Nov. 2, 2017

(54) PARZEN WINDOW FEATURE SELECTION ALGORITHM FOR FORMAL CONCEPT ANALYSIS (FCA)

(71) Applicant: HRL Laboratories, LLC, Malibu, CA (US)

(72) Inventors: Michael J. O'Brien, Culver City, CA (US); Kang-Yu Ni, Calabasas, CA (US); James Benvenuto, Beverly Hills, CA (US); Rajan Bhattacharyya, Sherman Oaks, CA (US)

(21) Appl. No.: 15/150,998

(22) Filed: May 10, 2016

Related U.S. Application Data
(63) Continuation-in-part of application No. 14/489,313, filed on Sep. 17, 2014, now Pat. No. 9,646,248.
Application No. 14/489,313 is a continuation-in-part of application No. 14/807,083, filed on Jul. 23, 2015.
Application No. 14/807,083 is a continuation-in-part of application No. 14/489,313, filed on Sep. 17, 2014, now Pat. No. 9,646,248.
(60) Provisional application No. 62/028,083, filed on Jul. 23, 2014.
(60) Provisional application No. 62/028,171, filed on Jul. 23, 2014.
(60) Provisional application No. 62/195,876, filed on Jul. 23, 2015.

(51) Int. Cl. G06K 9/00; G06T 7/00; G06K 9/46

(52) U.S. Cl. CPC G06K 9/00617; G06K 9/4604; G06T 7/0012; G06K 9/0061; G06T 2207/20081; G06T 2207/10088; G06T 2207/30016; G06T 2207/30041; G06T 2207/30104; G06T 2207/20076

(57) ABSTRACT

Described is a system for feature selection for formal concept analysis (FCA). A set of data points having features is separated into object classes. For each object class, the data points are convolved with a Gaussian function, resulting in a class distribution curve for each known object class. For each class distribution curve, a binary array is generated having ones on intervals of data values on which the class distribution curve is maximum with respect to all other class distribution curves, and zeroes elsewhere. For each object class, a binary class curve indicating for which interval a performance of the known object class exceeds all other known object classes is generated. The intervals are ranked with respect to a predetermined confidence threshold value. The ranking of the intervals is used to select which features to extract from the set of data points in FCA lattice construction.

### CROSS-REFERENCE TO RELATED APPLICATIONS

This is a Continuation-in-Part application of U.S. Non-Provisional application Ser. No. 14/489,313, filed in the United States on Sep. 17, 2014, entitled, “Mapping Across Domains to Extract Conceptual Knowledge Representation from Neural Systems,” which is a Non-Provisional patent application of U.S. Provisional Application No. 62/028,083, filed in the United States on Jul. 23, 2014, entitled, “Mapping Across Domains to Extract Conceptual Knowledge Representation from Neural Systems,” which are incorporated herein by reference in their entirety.

This is ALSO a Continuation-in-Part application of U.S. Non-Provisional application Ser. No. 14/807,083, filed in the United States on Jul. 23, 2015, entitled, “A General Formal Concept Analysis (FCA) Framework for Classification, which is a Continuation-in-Part application of U.S. Non-Provisional application Ser. No. 14/489,313, filed in the United States on Sep. 17, 2014, entitled, “Mapping Across Domains to Extract Conceptual Knowledge Representation from Neural Systems,” which is incorporated herein by reference in their entirety. U.S. Non-Provisional application Ser. No. 14/807,083 is ALSO a Non-Provisional application of U.S. Provisional Application No. 62/028,171, filed in the United States on Jul. 23, 2014, entitled, “A General Formal Concept Analysis (FCA) Framework for Classification,” which is incorporated herein by reference in its entirety.

This is ALSO a Non-Provisional patent application of U.S. Provisional Application No. 62/195,876, filed in the United States on Jul. 23, 2015, entitled, “A Parzen Window Feature Selection Algorithm for Formal Concept Analysis (FCA),” which is incorporated herein by reference in its entirety.

### GOVERNMENT LICENSE RIGHTS

This invention was made with government support under U.S. Government Contract Number FA8650-13-C7356. The government has certain rights in the invention.

### BACKGROUND OF INVENTION

### (1) Field of Invention

The present invention relates to a system for feature extraction for formal concept analysis (FCA) and, more particularly, to a system for feature extraction for FCA using Parzen windows.

### (2) Description of Related Art

Many forms of information can be described as a set of objects, each with a set of attributes and/or values. In these cases, any hierarchical structure remains implicit. Often the set of objects can be related to two or more completely different domains of attributes and/or values. Formal Concept Analysis (FCA) is a principled way of deriving a partial order on a set of objects, each defined by a set of attributes. It is a technique in data and knowledge processing that has applications in data visualization, data mining, information retrieval, and knowledge management (see the List of Incorporated Literature References, Literature Reference No. 2). The principle with which it organizes data is a partial order induced by an inclusion relation between object's attributes. Additionally, FCA admits rule mining from structured data.

FCA is widely applied for data analysis. FCA relies on binary features in order to construct lattices. There are techniques for converting scalar data to a binarized format, but they often result in the creation of too many attributes to be efficiently used in lattice construction. Feature selection on scalar data is typically done by scaling or creating uniform bins. Existing methods of selecting features from scalar data in FCA suffer from blind selection policies which yield too many and, typically, not useful features. This is problematic due to the exponentially increasing computational time required for lattice construction based on features.

Thus, a continuing need exists for reducing the number of features in FCA down to the most useful to allow for smaller lattices to be constructed without diminishing the powers of FCA.

### SUMMARY OF THE INVENTION

The present invention relates to a system for feature extraction for formal concept analysis (FCA) and, more particularly, to a system for feature extraction for FCA using Parzen windows. The system comprises one or more processors and a non-transitory computer-readable medium having executable instructions encoded thereon such that when executed, the one or more processors perform multiple operations. The system separates a set of data points having features into a set of known object classes. For each known object class, the data points are convolved with a Gaussian function, resulting in a class distribution curve for each known object class. For each class distribution curve, intervals of data values on which the class distribution curve is maximum with respect to all other class distribution curves are identified. The intervals are ranked with respect to a predetermined confidence threshold value. The ranking of the intervals are used to select which features to extract from the set of data points in FCA lattice construction, and the selected features are extracted from the set of data points.

In another aspect, the selected features are used to interpret neural data.

In another aspect, the selected features are applied to functional magnetic resonance imaging (fMRI) responses to classify a thought process of a human.

In another aspect, the system generates a binary array comprising ones and zeroes, having ones on intervals of data on which the class distribution curve is maximum, and zeroes elsewhere.

In another aspect, for each known object class, a binary class curve indicating for which interval a performance of the known object class exceeds all other known object classes is generated.

In another aspect, the set of data points comprises data from a neural sensor.

In another aspect, the predetermined confidence threshold value is used to eliminate intervals having a low confidence value.

In another aspect, the ranking of the intervals is determined by taking a ratio of an area under each class distribution curve along each interval to a sum of the areas under all the other class distribution curves along each interval.

In another aspect, the present invention also comprises a method for causing a processor to perform the operations described herein.

Finally, in yet another aspect, the present invention also comprises a computer program product comprising computer-readable instructions stored on a non-transitory computer-readable medium that are executable by a computer having a processor for causing the processor to perform the operations described herein.

### BRIEF DESCRIPTION OF THE DRAWINGS

The file of this patent or patent application publication contains at least one drawing executed in color. Copies of this patent or patent application publication with color drawing(s) will be provided by the Office upon request and payment of the necessary fee.

The objects, features and advantages of the present invention will be apparent from the following detailed descriptions of the various aspects of the invention in conjunction with reference to the following drawings, where:

FIG. 1 is a block diagram depicting the components of a system for feature extraction for formal concept analysis (FCA) according to embodiments of the present invention;

FIG. 2 is an illustration of a computer program product according to embodiments of the present invention;

FIG. 3 is an illustration of a first context table according to embodiments of the present invention;

FIG. 4A is an illustration of a second context table according to embodiments of the present invention;

FIG. 4B is an illustration of a lattice resulting from the data in the second context table according to embodiments of the present invention;

FIG. 5 is an illustration of a process flow of feature extraction for FCA according to embodiments of the present invention;

FIG. 6 is an illustration of growth in number of lattice nodes required for high classification standards using uniform bins compared to Parzen windows according to embodiments of the present invention;

FIG. 7 is an illustration of growth in number of lattice edges required for high classification standards using uniform bins compared to Parzen windows according to embodiments of the present invention;

FIG. 8 is an illustration of classification accuracy as a function of threshold value and Parzen window size σ according to embodiments of the present invention;

FIG. 9 is an illustration of a number of lattice nodes built as a function of threshold value and Parzen window size a according to embodiments of the present invention;

FIG. 10A is an illustration of class distribution curves according to embodiments of the present invention;

FIG. 10B is an illustration of individual binary class curves for each object class according to embodiments of the present invention;

FIG. 11 is an illustration of confidence values of the class distribution curves according to embodiments of the present invention; and

FIG. 12 is an illustration of recording of neural responses and FCA classification of the neural responses according to embodiments of the present invention.

### DETAILED DESCRIPTION

The present invention relates to a system for feature extraction for formal concept analysis (FCA) and, more particularly, to a system for feature extraction for FCA using Parzen windows. The following description is presented to enable one of ordinary skill in the art to make and use the invention and to incorporate it in the context of particular applications. The application discussed is for analyzing brain activity in response to different stimuli using FCA by constructing a lattice using the feature extraction method in this invention. Various modifications, as well as a variety of uses in different applications will be readily apparent to those skilled in the art, and the general principles defined herein may be applied to a wide range of aspects. Thus, the present invention is not intended to be limited to the aspects presented, but is to be accorded the widest scope consistent with the principles and novel features disclosed herein.

In the following detailed description, numerous specific details are set forth in order to provide a more thorough understanding of the present invention. However, it will be apparent to one skilled in the art that the present invention may be practiced without necessarily being limited to these specific details. In other instances, well-known structures and devices are shown in block diagram form, rather than in detail, in order to avoid obscuring the present invention.

The reader's attention is directed to all papers and documents which are filed concurrently with this specification and which are open to public inspection with this specification, and the contents of all such papers and documents are incorporated herein by reference. All the features disclosed in this specification, (including any accompanying claims, abstract, and drawings) may be replaced by alternative features serving the same, equivalent or similar purpose, unless expressly stated otherwise. Thus, unless expressly stated otherwise, each feature disclosed is one example only of a generic series of equivalent or similar features.

Furthermore, any element in a claim that does not explicitly state “means for” performing a specified function, or “step for” performing a specific function, is not to be interpreted as a “means” or “step” clause as specified in 35 U.S.C. Section 112, Paragraph 6. In particular, the use of “step of” or “act of” in the claims herein is not intended to invoke the provisions of 35 U.S.C. 112, Paragraph 6.

Please note, if used, the labels left, right, front, back, top, bottom, forward, reverse, clockwise and counter-clockwise have been used for convenience purposes only and are not intended to imply any particular fixed direction. Instead, they are used to reflect relative locations and/or directions between various portions of an object. As such, as the present invention is changed, the above labels may change their orientation.

Before describing the invention in detail, first a list of cited literature references used in the description is provided. Next, a description of various principal aspects of the present invention is provided. Following that is an introduction that provides an overview of the present invention. Finally, specific details of the present invention are provided to give an understanding of the specific aspects.

### (1) LIST OF INCORPORATED LITERATURE REFERENCES

The following references are cited and incorporated throughout this application. For clarity and convenience, the references are listed herein as a central resource for the reader. The following references are hereby incorporated by reference as though fully included herein. The references are cited in the application by referring to the corresponding literature reference number, as follows:
1. V. Arulmozhi. Classification task by using Matlab Neural Network Tool Box—A beginners. International Journal of Wisdom Based Computing, 2011.
2. G. Romano C. Carpineto. Concept Data Analysis: Theory and Applications. Wiley, Chapter 2, 2004.
3. Richard O. Duda, Peter E. Hart, and David G. Stork. Pattern Classification. Wiley-Interscience, 2nd edition, Chapter 4, Section 3, 2001.
4. B. Ganter and R. Wille. Formal Concept Analysis: Mathematical Foundations. Springer-Verlag, Chapter 1, 1998.
5. M. Swain, S. K. Dash, S. Dash, and A. Mohapatra. An approach for IRIS plant classification using neural network. International Journal of Soft Computing, 2012.
6. K. Bache and M. Lichman. UCI machine learning repository. University of California, Irvine, School of Information and Computer Sciences, 2013, available at h t p : / / archive.ics.uci.edu/ml/datasets/Iris taken on Jul. 17, 2015.

### (2) PRINCIPAL ASPECTS

Various embodiments have three “principal” aspects. The first is a system for Parzen window feature selection for formal concept analysis (FCA). The system is typically in the form of a computer system operating software or in the form of a “hard-coded” instruction set. This system may be incorporated into a wide variety of devices that provide different functionalities, such as a robot or other device. The second principal aspect is a method, typically in the form of software, operated using a data processing system (computer). The third principal aspect is a computer program product. The computer program product generally represents computer-readable instructions stored on a non-transitory computer-readable medium such as an optical storage device, e.g., a compact disc (CD) or digital versatile disc (DVD), or a magnetic storage device such as a floppy disk or magnetic tape. Other, non-limiting examples of computer-readable media include hard disks, read-only memory (ROM), and flash-type memories. These aspects will be described in more detail below.

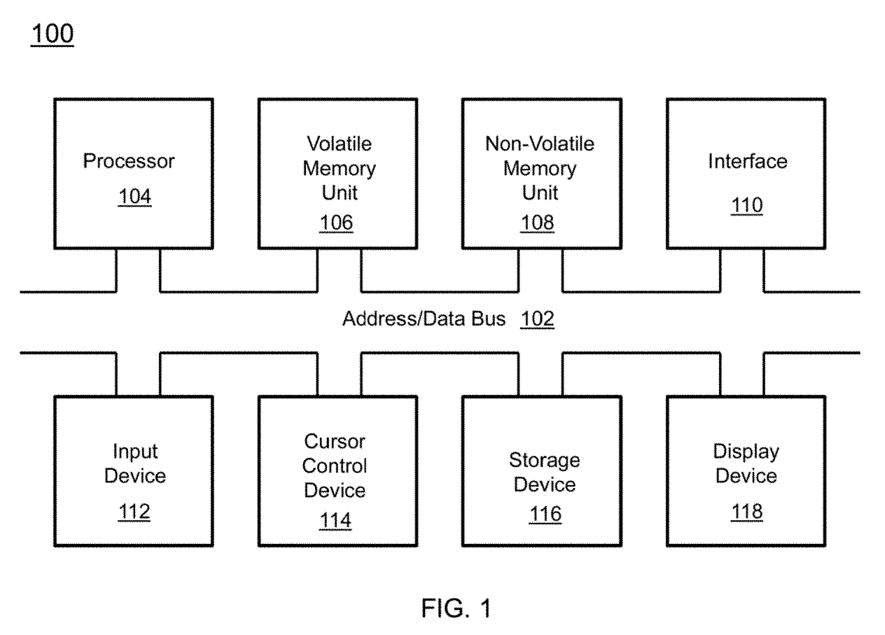

A block diagram depicting an example of a system (i.e., computer system 100) of the present invention is provided in FIG. 1. The computer system 100 is configured to perform calculations, processes, operations, and/or functions associated with a program or algorithm. In one aspect, certain processes and steps discussed herein are realized as a series of instructions (e.g., software program) that reside within computer readable memory units and are executed by one or more processors of the computer system 100. When executed, the instructions cause the computer system 100 to perform specific actions and exhibit specific behavior, such as described herein.

The computer system 100 may include an address/data bus 102 that is configured to communicate information. Additionally, one or more data processing units, such as a processor 104 (or processors), are coupled with the address/data bus 102. The processor 104 is configured to process information and instructions. In an aspect, the processor 104 is a microprocessor. Alternatively, the processor 104 may be a different type of processor such as a parallel processor, or a field programmable gate array.

The computer system 100 is configured to utilize one or more data storage units. The computer system 100 may include a volatile memory unit 106 (e.g., random access memory (“RAM”), static RAM, dynamic RAM, etc.) coupled with the address/data bus 102, wherein a volatile memory unit 106 is configured to store information and instructions for the processor 104. The computer system 100 further may include a non-volatile memory unit 108 (e.g., read-only memory (“ROM”), programmable ROM (“PROM”), erasable programmable ROM (“EPROM”), electrically erasable programmable ROM “EEPROM”), flash memory, etc.) coupled with the address/data bus 102, wherein the non-volatile memory unit 108 is configured to store static information and instructions for the processor 104. Alternatively, the computer system 100 may execute instructions retrieved from an online data storage unit such as in “Cloud” computing. In an aspect, the computer system 100 also may include one or more interfaces, such as an interface 110, coupled with the address/data bus 102. The one or more interfaces are configured to enable the computer system 100 to interface with other electronic devices and computer systems. The communication interfaces implemented by the one or more interfaces may include wireline (e.g., serial cables, modems, network adaptors, etc.) and/or wireless (e.g., wireless modems, wireless network adaptors, etc.) communication technology.

In one aspect, the computer system 100 may include one or more of an input device 112 coupled with the address/data bus 102, wherein the input device 112 is configured to communicate information and command selections to the processor 100. In accordance with one aspect, the input device 112 includes an alphanumeric input device, such as a keyboard, that may include alphanumeric and/or function keys. Alternatively, or in addition, the input device 112 may include an input device other than an alphanumeric input device. For example, the input device 112 may include one or more sensors such as a camera for video or still images, a microphone, or a neural sensor. Other example input devices 112 may include an accelerometer, a GPS sensor, or a gyroscope.

In an aspect, the computer system 100 further may include one or more optional computer usable data storage devices, such as a storage device 116, coupled with the address/data bus 102. The storage device 116 is configured to store information and/or computer executable instructions. In one aspect, the storage device 116 is a storage device such as a magnetic or optical disk drive (e.g., hard disk drive (“HDD”), floppy diskette, compact disk read only memory (“CD-ROM”), digital versatile disk (“DVD”)). Pursuant to one aspect, a display device 118 is coupled with the address/data bus 102, wherein the display device 118 is configured to display video and/or graphics. In an aspect, the display device 118 may include a cathode ray tube (“CRT”), liquid crystal display (“LCD”), field emission display (“FED”), plasma display, or any other display device suitable for displaying video and/or graphic images and alphanumeric characters recognizable to a user.

The computer system 100 presented herein is an example computing environment in accordance with an aspect. However, the non-limiting example of the computer system 100 is not strictly limited to being a computer system. For example, an aspect provides that the computer system 100 represents a type of data processing analysis that may be used in accordance with various aspects described herein. Moreover, other computing systems may also be implemented. Indeed, the spirit and scope of the present technology is not limited to any single data processing environment. Thus, in an aspect, one or more operations of various aspects of the present technology are controlled or implemented using computer-executable instructions, such as program modules, being executed by a computer. In one implementation, such program modules include routines, programs, objects, components and/or data structures that are configured to perform particular tasks or implement particular abstract data types. In addition, an aspect provides that one or more aspects of the present technology are implemented by utilizing one or more distributed computing environments, such as where tasks are performed by remote processing devices that are linked through a communications network, or such as where various program modules are located in both local and remote computer-storage media including memory-storage devices.

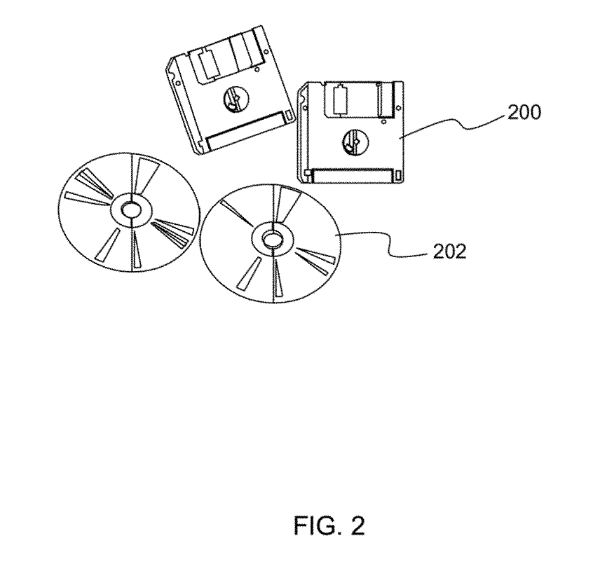

An illustrative diagram of a computer program product (i.e., storage device) embodying the present invention is depicted in FIG. 2. The computer program product is depicted as floppy disk 200 or an optical disk 202 such as a CD or DVD. However, as mentioned previously, the computer program product generally represents computer-readable instructions stored on any compatible non-transitory computer-readable medium. The term “instructions” as used with respect to this invention generally indicates a set of operations to be performed on a computer, and may represent pieces of a whole program or individual, separable, software modules. Non-limiting examples of “instruction” include computer program code (source or object code) and “hard-coded” electronics (i.e. computer operations coded into a computer chip). The “instruction” is stored on any non-transitory computer-readable medium, such as in the memory of a computer or on a floppy disk, a CD-ROM, and a flash drive. In either event, the instructions are encoded on a non-transitory computer-readable medium.

### (3) INTRODUCTION

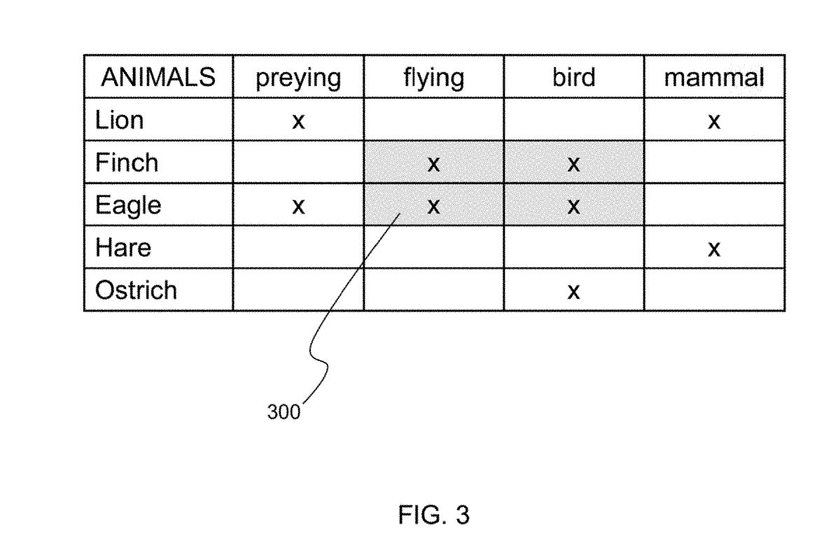

Formal concept analysis (FCA) is a principled way of deriving a concept hierarchy or formal ontology from a collection of objects and their properties or attributes. It is a creation of a partial order of the objects based on an ordering relation defined by set inclusion of attributes. Formally, a context=(G, M, I) consists of two sets G and M and a relation I, called the incidence relation, between them. The elements of G are called the objects, and the elements of M are called the attributes (see Literature Reference No. 4). If an object gεG has the attribute mεM, then write glm or (g, m)εI. A context can be represented by a cross table, or context table, which is a rectangular table where the rows are headed by objects and the columns are headed by attributes, an example of which is illustrated in FIG. 3. An “X” in the intersection of row g and column m means that object g has attribute m. For a set A⊂G of objects, one can define A′={mεM|glm∀gεA}. In words, for some subset of objects A, A′ represents the set of attributes common to all the objects in A. Correspondingly, one can define B′={gεG|glm∀mεM}. In words, for some subset of attributes B, B′ represents the set of objects which have all the attributes in B.

A formal concept can now be defined. A formal concept of the context (G, M, I) is a pair (A, B) with A⊂G, B⊂M, A′=B, and B′=A. A is called the extent, and B is called the intent of the concept (A, B). (G, M, I) denotes the set of all concepts of the context (G, M, I). A concept is represented within a context table by a maximal contiguous block of “X”'s after arbitrary rearrangement of rows and columns, as shown in FIG. 3. Algorithms for determining concept lattices are described in Literature Reference Nos. 2 and 4. Mathematically, the key aspect of concept lattices is that a concept lattice [symbol] (G, M, I) is a complete lattice in which the infimum and supremum are, respectively, given by:

[symbol]

_{tεT}(Aₜ,Bₜ)=(∩_{tεT}Aₜ,(∪_{tεT}Bₜ)″) and

[symbol]

_{tεT}(Aₜ,Bₜ)=((∪_{tεT}Aₜ)″,∩_{tεT}Bₜ).

Referring to FIG. 3, an object (e.g., lion) has the attributes from the columns corresponding to the “X”'s (e.g., preying, mammal). The contiguous block of grey 300 is maximal, under any rearrangements of rows and columns, and forms a formal concept. The supremum is called the join and is written z [symbol] y or sometimes [symbol] S (the join of the set S). The infimum is called the meet and is written z [symbol] y or sometimes [symbol] S (the meet of the set S). An extensive description of formal concept analysis is given in Literature Reference No. 4.

(3.1) Example of a Context and Concept Lattice

A concept lattice is a mathematical object represented by (G, M, I) as described above. A concept lattice can be visualized by a Hasse diagram, a directed acyclic graph where the nodes represent concepts and lines represent the inclusion relationship between the nodes. In the case of formal concept analysis, the Hasse diagram has a single top node representing all objects (given by G), and a single bottom node representing all attributes (given by M). All the nodes in between represent the various concepts comprised of some subset of objects and attributes. A line between two nodes represents the order information. The node above is considered greater than the node below. In a Hasse diagram, a node in with attribute set m and object set g has the following properties:
m=g′, is the set of all attributes shared by every object in g.
g=m′, is the set of all objects that have all attributes in m.
Every child node of n has all of m in its intent.
Every parent node of n has all of g in its extent.

Thus, the ordering of the nodes within the lattice n>k implies that the extent of n is contained in the extent of k and, equivalently, the intent of n is contained in the intent of k. The upset of a node n consists of all of its ancestor nodes within the lattice. The downset of n consists of all its children nodes within the lattice.

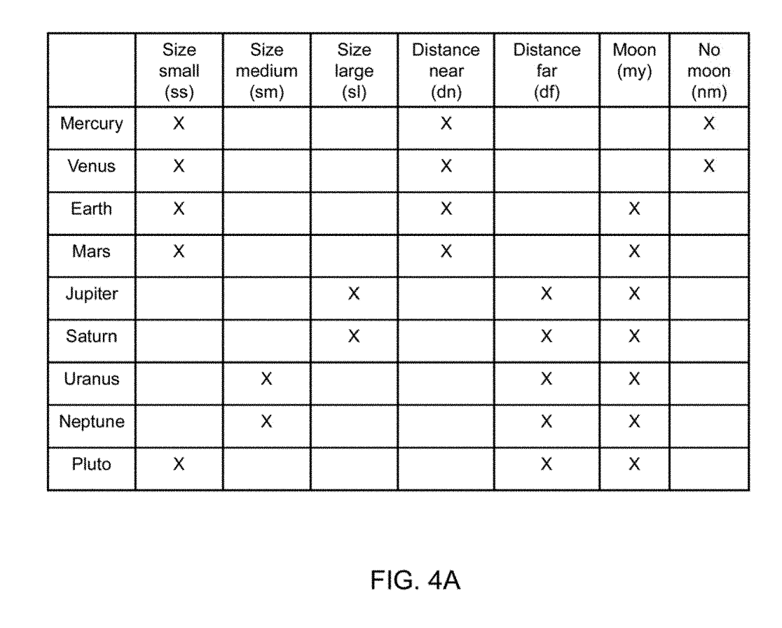

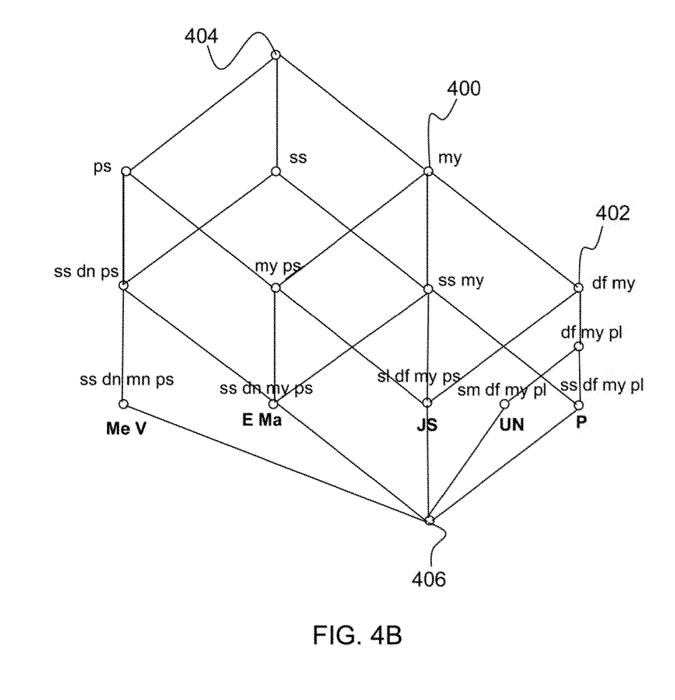

FIGS. 4A and 4B illustrate a context table and the corresponding Hasse diagram of the concept lattice induced by the formal content, respectively. The objects are nine planets, and the attributes are properties, such as size, distance to the sun, and presence or absence of moons. Each node (represented by circles, such as elements 400 and 402) corresponds to a concept, with its objects consisting of the union of all objects from nodes connecting from above, and attributes consisting of the intersection of all attributes of all the nodes connecting from below. Ultimately, the top most node 404 contains all the objects, G, and now attributes. Correspondingly, the bottom most node 406 contains all the attributes, M, and no objects.

(4) Specific Details of the Invention

In the system according to some embodiments of the present invention, feature selection is performed on scalar data from BOLD (blood oxygenation level dependent) responses measured using fMRI (functional magnetic resonance imaging). fMRI is a functional neuroimaging procedure using MRI technology that measures brain activity by detecting changes associated with blood flow. This technique relies on the fact that cerebral blood flow and neuronal activation are coupled. When an area of the brain is in use, blood flow to that region also increases. fMRI typically provides a dataset that can consist of samples of brain activity (inferred from the BOLD signal) from 20 k-100 k (where k represents “thousand”) voxels, in response to stimuli. Feature selection from this high dimensional scalar data is performed to extract signal from noise in the voxel responses. The selected features can then be further analyzed using methods, such as FCA, to understand their structure and contribution to activity in response to stimuli (referred to as object class below), and further be used to decode brain activity back into stimulus dimensions.

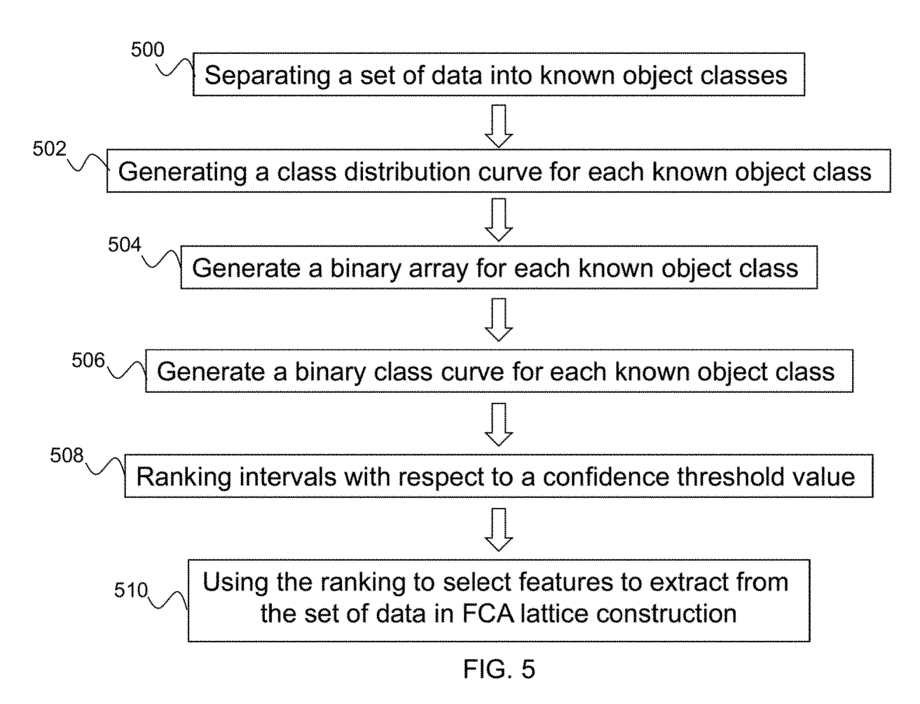

FIG. 5 is a flow diagram depicting Parzen window feature selection for FCA according to embodiments of the present invention. In a first operation 500, a set of data is separated into known object classes. Non-limiting examples of data sets that can be separated into known object classes include fMRI BOLD responses, and data from sensors in an environment, such as imaging data from cameras, radar, and LIDAR. In a second operation 502, a class distribution curve is generated for each object class. Following that, a binary array is generated for each object class in a third operation 504. In a fourth operation 506, a binary class curve is generated from the binary array. Next, intervals are ranked with respect to a confidence threshold value in a fifth operation 508. Finally, in a fifth operation 510, the ranking is used to select features to extract from the set of data for FCA lattice construction. Each of these operations is described in further detail below.

(4.1) Feature Selection

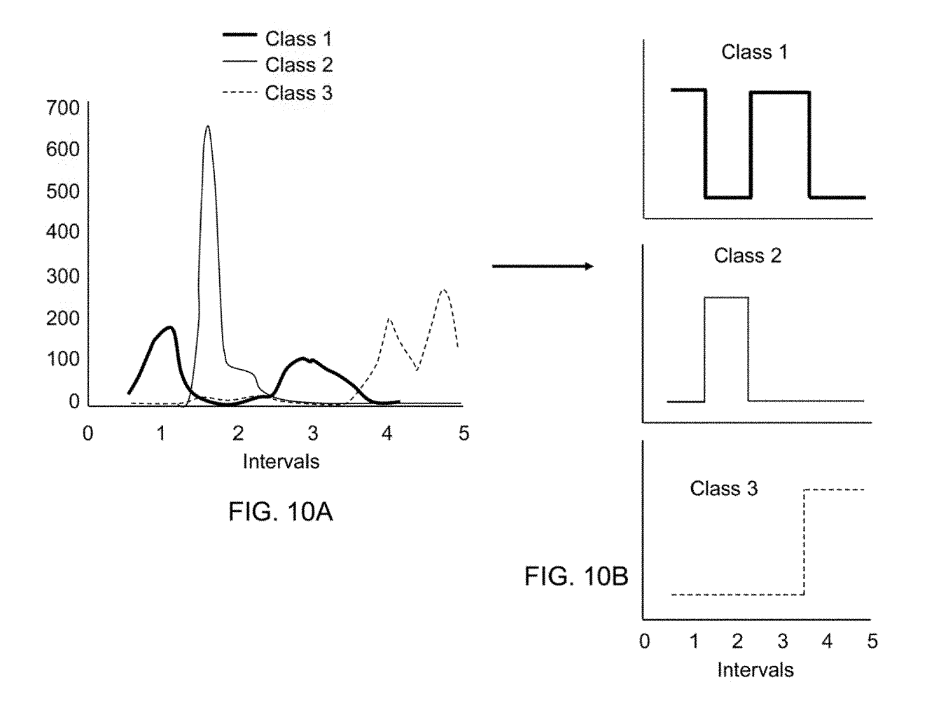

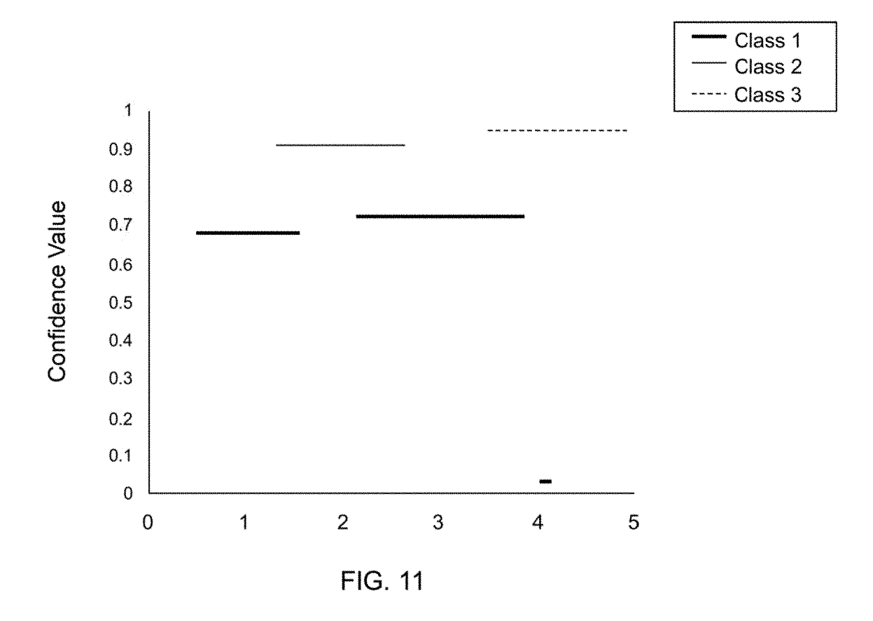

A Parzen window density estimation is used in determining appropriate bins for the scalar data values (see Literature Reference No. 3 for a description of Parzen window density estimation). The method according to some embodiments of the present invention consists of separating the data points into the separate known object classes. For each class, the data points are convolved with a Gaussian function. The resulting curves are called class distribution curves, which are depicted in FIG. 10A. For each class, the corresponding class distribution curve is compared to the other class distribution curves. A binary array is created, consisting of ones on the intervals on which the class distribution curve is maximum (with respect to ALL of the other class distribution curves), and zeros elsewhere. This is the binary class curve, indicating which intervals of data values the class has the highest probability of inclusion in the interval against all other classes. An illustration of an individual binary class curve for each object class is shown in FIG. 10B. These intervals are then ranked with respect to the confidence in them, where confidence is computed by the ratio of a given class's inclusion in the interval to the sum of inclusion by all classes. The confidence values of the example in FIG. 10A are shown in FIG. 1.

Formally, the algorithm ParzenFeatureSelection is as follows. Let Gauss(μ) be a Gaussian with mean μ and standard deviation σ. Cₒ is used for the class curve of the object o, and the resulting bins is bₒ. The corresponding confidence value is Cₒ. The outputs are bins, which is a list of the beginning value and ending value of the intervals, and confs, which is the list of confidence levels for each interval.

```
Require: X, vector of scalar data from the input such as fMRI BOLD
voxel activities, obj corresponding object classes, thresh a confidence
cutoff threshold
    1: bins = [ ], confs = [ ]
    2: for all o ε obj do
    3:  xₒ = {X[i] | obj[i] = o}
    4:  Cₒ = Σₓₑₓ_{ₒ} Gauss(x)
    5: end for
    6: Cₘₐₓ(t) = maxₒCₒ(t)
    7: Curves = {Cₒ | o ε obj}
    8: for all o ε obj do
    9:  bₒ = {[a,b]| Cₒ(t) = Cₘₐₓ(t) ∀ t ε [a,b]}
  10:  cₒ = confidence(o,Curves)
  11:  if cₒ ≧ thresh then
  12:  bins.push_back(bₒ)
  13:  confs.push_back(cₒ)
  14:  end if
  15: end for
  16: return bins, confs
```

This ranking in confidence can be done in a variety of ways, a non-limiting example of which is described below. The ranks are established by taking the ratio of the area under the class distribution curve along the interval to the sum of the areas of all the other class distribution curves along the interval. In our application, an fMRI experiment measures brain activity as voxel values in response to different stimulus classes (e.g., class A and B) repeatedly to produce multiple measurement samples. For example, if the input data voxel value achieves 3.7 for 10 different samples, and 7 of the samples are associated with an element of class A, and 3 of the samples are other classes, then if the value 3.7 is observed in another sample, one can be 70% confident it is an instance of class A. A predetermined threshold value is used to throw out intervals with low confidence values. Other methods for confidence level computation may prove useful depending on the statistics of the data (number of samples, distribution of sample values). The following are non-limiting examples of confidence level computation:
Incorporate the size of the bin, giving higher confidences to larger bins.
Break up the bin into pieces where the central piece is given a higher confidence, and the edge pieces are given lower confidences.
Use different, non-linear confidence calculations. For example, use the Fisher discriminant. Consider the mean and scatter of response samples for each class from a voxel. Define the mean (m_{A}) and scatter response (s_{A}) to class A, where scatter is determined by s_{A}²=(x₁−m_{A})²+ . . . +(xₖ−m_{A})², for the xᵢ responses of the voxel to class A and, similarly, we define the mean of the rest (m_{R}) and the scatter of the rest (s_{R}) is defined for all responses to other classes. Given these definitions, the Fisher discriminant is defined as F(A)=|m_{A}−m_{R}|²/(s_{A}²+s_{R}²). The stability of the voxel can then be defined as max_{A}F(A). The advantage of this measurement is that it maximizes the distance between the mean of class A and the rest of the values, while minimizing the variance of responses to class A and the responses to the rest of the classes.

(4.2) Experimental Studies

Studies were performed on two sets of data for classification. The first is the Iris data set available in the University of California, Irvine (UCI) machine learning repository (see Literature Reference No. 7 for the Iris data set). In this problem, the goal is to classify the iris type based on ‘sepal length’, ‘sepal width’, ‘petal length’, and ‘petal width’. The second data set was comprised of fMRI BOLD responses.

(4.2.1) Iris

Classification of the Iris data set was performed using the algorithm described in U.S. Non-Provisional application Ser. No. 14/807,083, which is hereby incorporated by reference as though fully set forth herein. Using the present invention, it was possible to classify the data set with much smaller lattices compared to previous techniques, such as uniform binning of the data, making the classification much quicker.

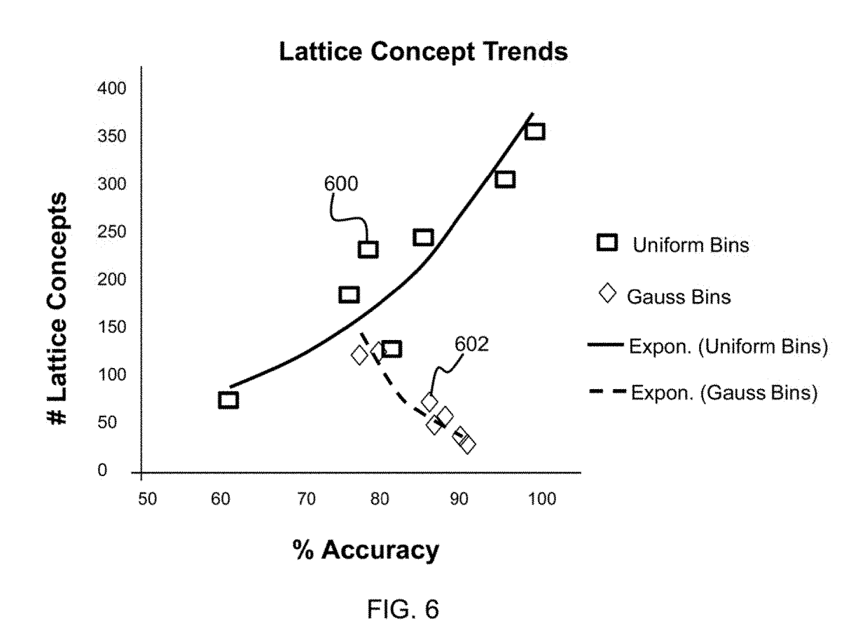

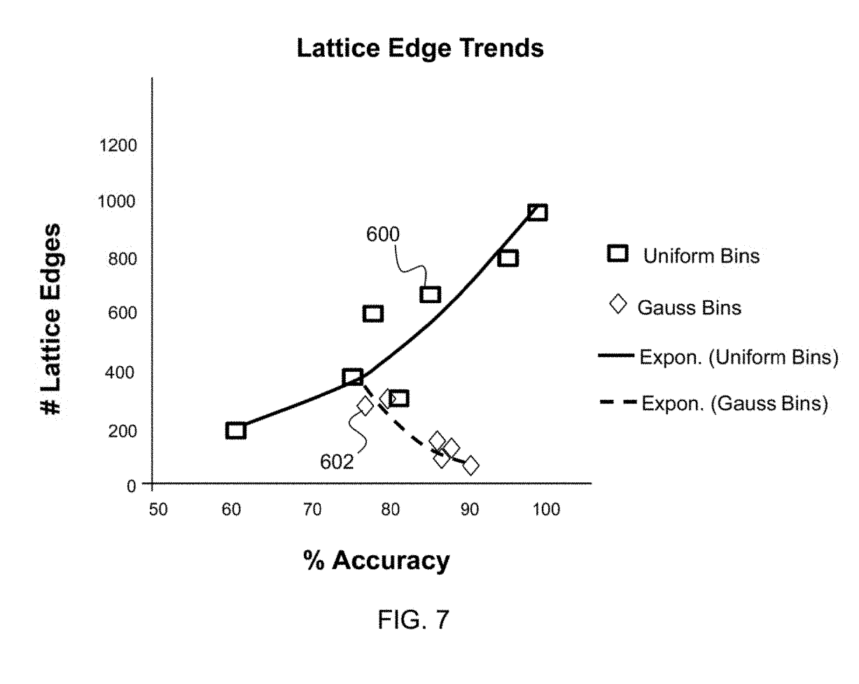

FIGS. 6 and 7 demonstrate the growth required for high classification standards using uniform bins (represented by rectangles 600), compared to Parzen windows (commonly referred to as Gaussian Bins represented by diamonds 602) according to various embodiments of the present invention. Note that 90% accuracy is achieved with fewer than 50 concepts (or nodes) of the lattice (as shown in FIG. 6) and less than 100 edges (as shown in FIG. 7).

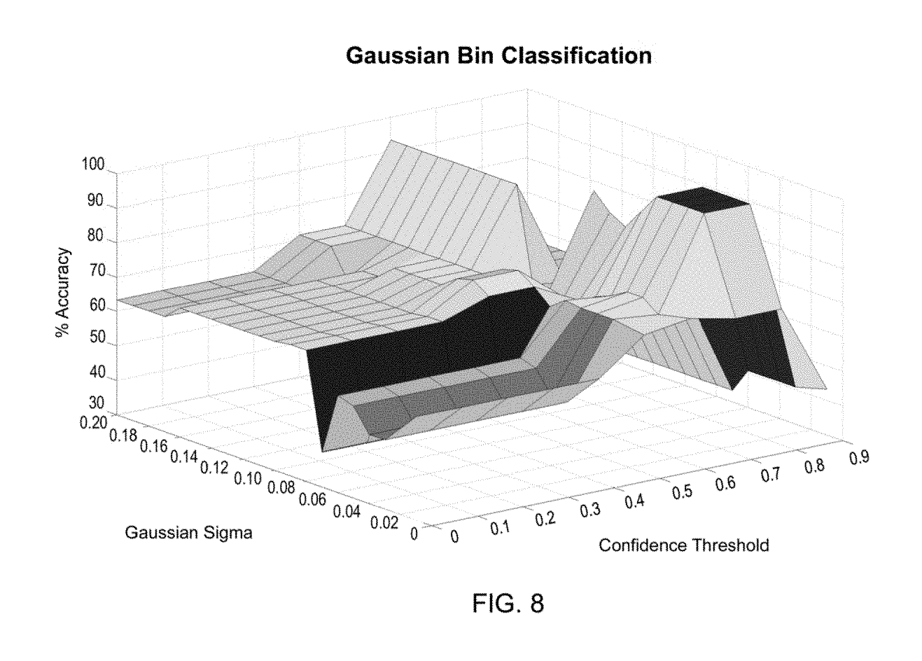

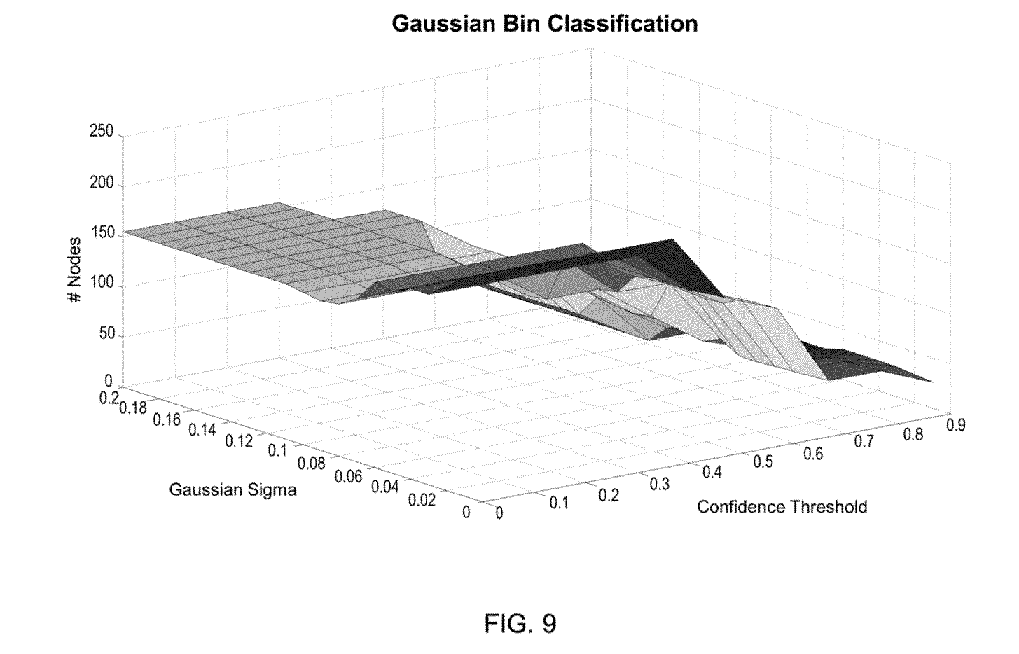

Additionally, a study was performed to see if the classification accuracy could be boosted while still maintaining a small lattice structure. The results are depicted in FIGS. 8 and 9 in the form of three-dimensional (3D) plots, where color value corresponds to the z-axis value in each plot. Blue represents the minimum value in the z-axis (e.g., z-axis minimum in FIG. 8 for % accuracy is 30), and red represents the maximum value. FIG. 8 illustrates classification accuracy (z-axis and color, labeled % accuracy) as a function of threshold value (x-axis, labeled confidence threshold) and Parzen window size σ (y-axis, labeled Gaussian sigma).

FIG. 9 illustrates number of lattice nodes (z-axis and color, labeled # nodes) built as a function of threshold value (x-axis, labeled confidence threshold) and Parzen window size a (y-axis, labeled Gaussian Sigma). The points in each of the plots correspond to each other, so the area with x=0.7-0.8 (confidence threshold) and y=0.02-0.06 (Gaussian Sigma) correspond to z=97% (% Accuracy in FIG. 7) and z=50 (# nodes in FIG. 9). As shown, the results indicated that 97% accuracy was able to be achieved while needing less than 50 nodes. This is better than published state-of-the-art classification techniques on this data set (see Literature Reference Nos. 1 and 5).

(4.2.2) Functional Magnetic Resonance Imaging (fMRI) Blood-Oxygen-Level Dependent (BOLD) Responses

(4.2.2.1) Voxel Binning

fMRI BOLD responses are used to represent a level of neural activity within the brain in a non-invasive way. Various stimuli (e.g., spoken words, written words, images) are presented, representing semantic or conceptual input. During the presentation of stimuli, the brain's responses are recorded. A baseline of null activity is subtracted out and the difference between this neutral brain state and the brain's state in response to the stimuli is extracted.

The set of stimuli (whether individual words of sentences, spoken words, images, etc.) represent the objects of formal concept analysis (FCA), and the extracted fMRI BOLD responses for the voxels within the brain represent the attributes of the objects. FCA classification (described in U.S. Non-Provisional application Ser. No. 14/807,083) can then be applied to the fMRI BOLD responses in an effort to classify the thought process of a human. To these ends, feature extraction via the Parzen window binning algorithm of the present invention is employed.

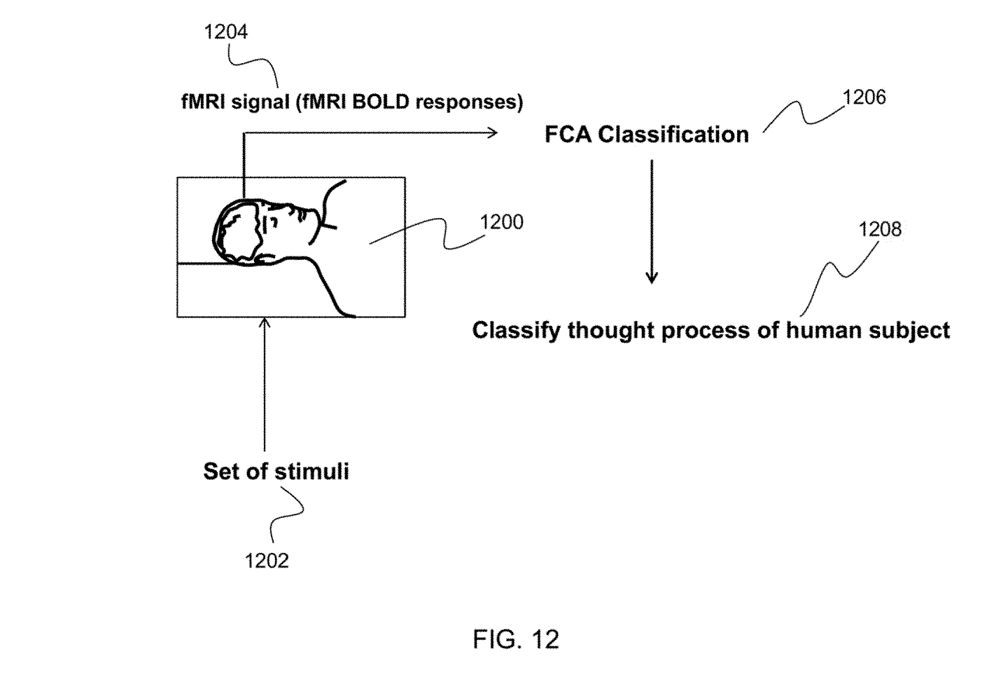

FIG. 12 illustrates a human subject 1200 being presented with a set of stimuli 1202 (e.g., spoken words, written words, images). During the presentation of the set of stimuli 1202, fMRI BOLD responses 1204 are recorded in response to the set of stimuli 1202. Since the set of stimuli 1202 represents the objects of FCA, and the extracted fMRI BOLD responses 1204 represent the attributes of the objects, FCA classification 1206 can then be applied to the fMRI BOLD responses 1204 in an effort to classify the thought process of a human 1208.

The invention described herein has multiple applications. For instance, as described above, FCA classification is instrumental to the classification of fMRI BOLD responses to presented stimuli. Further, the method according to some embodiments of the present invention can be used to classify inefficiencies within a production line or a circuit design, since many such inefficiencies are dependency based, resulting from the hidden structures within the production process.

What is claimed is:

1. A system for feature selection for formal concept analysis (FCA), the system comprising:
one or more processors having associated memory with executable instructions encoded thereon such that when executed, the one or more processors perform operations of:
separating a set of data points having features into a set of known object classes;
for each known object class, convolving the data points with a Gaussian function, resulting in a class distribution curve for each known object class;
for each class distribution curve, identifying intervals of data values on which the class distribution curve is maximum with respect to all other class distribution curves;
ranking the intervals with respect to a predetermined confidence threshold value;
using the ranking of the intervals to select which features to extract from the set of data points in FCA lattice construction; and
extracting the selected features from the set of data points.

2. The system as set forth in claim 1, wherein the selected features are used to interpret neural data.

3. The system as set forth in claim 2, wherein the selected features are applied to functional magnetic resonance imaging (fMRI) responses to classify a thought process of a human.

4. The system as set forth in claim 1, wherein the one or more processors further perform an operation of generating a binary array comprising ones and zeroes, having ones on intervals of data on which the class distribution curve is maximum, and zeroes elsewhere.

5. The system as set forth in claim 4, wherein for each known object class, a binary class curve indicating for which interval a performance of the known object class exceeds all other known object classes is generated.

6. The system as set forth in claim 1, wherein the set of data points comprises data from a neural sensor.

7. The system as set forth in claim 1, wherein the predetermined confidence threshold value is used to eliminate intervals having a low confidence value.

8. The system as set forth in claim 1, wherein the ranking of the intervals is determined by taking a ratio of an area under each class distribution curve along each interval to a sum of the areas under all the other class distribution curves along each interval.

9. A computer-implemented method for feature selection for formal concept analysis (FCA), comprising:
an act of causing one or more processors to execute instructions stored on a non-transitory memory such that upon execution, the one or more processors perform operations of:
separating a set of data points having features into a set of known object classes;
for each known object class, convolving the data points with a Gaussian function, resulting in a class distribution curve for each known object class;
for each class distribution curve, identifying intervals of data values on which the class distribution curve is maximum with respect to all other class distribution curves;
ranking the intervals with respect to a predetermined confidence threshold value;
using the ranking of the intervals to select which features to extract from the set of data points in FCA lattice construction; and
extracting the selected features from the set of data points.

10. The method as set forth in claim 9, wherein the selected features are used to interpret neural data.

11. The method as set forth in claim 10, wherein the selected features are applied to functional magnetic resonance imaging (fMRI) responses to classify a thought process of a human.

12. The method as set forth in claim 9, wherein the one or more processors further perform an operation of generating a binary array comprising ones and zeroes, having ones on intervals of data on which the class distribution curve is maximum, and zeroes elsewhere.

13. The method as set forth in claim 12, wherein for each known object class, a binary class curve indicating for which interval a performance of the known object class exceeds all other known object classes is generated.

14. The method as set forth in claim 9, wherein the predetermined confidence threshold value is used to eliminate intervals having a low confidence value.

15. A computer program product for feature selection for formal concept analysis (FCA), the computer program product comprising computer-readable instructions stored on a non-transitory computer-readable medium that are executable by a computer having one or more processors for causing the processor to perform operations of:
separating a set of data points having features into a set of known object classes;
for each known object class, convolving the data points with a Gaussian function, resulting in a class distribution curve for each known object class;
for each class distribution curve, identifying intervals of data values on which the class distribution curve is maximum with respect to all other class distribution curves;
ranking the intervals with respect to a predetermined confidence threshold value;
using the ranking of the intervals to select which features to extract from the set of data points in FCA lattice construction; and
extracting the selected features from the set of data points.

16. The computer program product as set forth in claim 15, wherein the selected features are used to interpret neural data.

17. The computer program product as set forth in claim 16, wherein the selected features are applied to functional magnetic resonance imaging (fMRI) responses to classify a thought process of a human.

18. The computer program product as set forth in claim 15, further comprising instructions for causing the one or more processors to perform an operation of generating a binary array comprising ones and zeroes, having ones on intervals of data on which the class distribution curve is maximum, and zeroes elsewhere.

19. The computer program product as set forth in claim 18, wherein for each known object class, a binary class curve indicating for which interval a performance of the known object class exceeds all other known object classes is generated.

20. The computer program product as set forth in claim 15, wherein the predetermined confidence threshold value is used to eliminate intervals having a low confidence value.
